(19) United States
(12) Patent Application Publication
(10) Pub. No.: US 2008/0309685 A1
(43) Pub. Date: Dec. 18, 2008

(54) LCD PANEL DRIVING CIRCUIT

(75) Inventor: Kenichi Miyamoto, Miyazaki (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/134,396

(22) Filed: Jun. 6, 2008

(30) Foreign Application Priority Data
Jun. 15, 2007 (JP) 2007-158883

(51) Int. Cl. G09G 5/10

(52) U.S. Cl. 345/690

(57) ABSTRACT

The LCD panel driving circuit includes a plurality of supply signal lines and feedback signal lines provided for respective differential driving amplifiers. Each driving amplifier has two input terminals, and generates a gradation signal in accordance with a write potential supplied to one of the two input terminals. The supply signal lines supply to the gradation signal lines the gradation signals, that are produced by the differential driving amplifiers, via first connection points. The feedback signal lines are connected to the gradation signal lines at second connection points. Each feedback signal line sends a potential at its second connection point to the other differential input terminal of the associated differential driving amplifier.

### BACKGROUND OF THE INVENTION

1. Field of the Invention

The present invention relates to a driving circuit that drives a liquid crystal display panel (hereinafter called “LCD panel”).

2. Description of the Related Art

LCD panels are used as a display unit for various information devices ranging from mobile phones to personal computers. Usually there are wide range of standards for the number of display pixels of an LCD panel from QVGA (Quarter Video Graphics Array: 320×240) to UXGA (Ultra Extended Graphics Array: 1600×1200) depending on the size of a display screen of an information device.

Referring to FIG. 1 of the accompanying drawings, an LCD panel driving circuit 100 will be described. This LCD panel driving circuit 100 drives a QVGA-compliant LCD panel 200 in synchronization with screen-scanning by a scanning circuit 300. The LCD panel 200 has a plurality of source lines and a plurality of gate lines, and the source lines intersect the gate lines. Such source lines and gate lines may be collectively referred to as a “source line-gate line array.” The LCD panel 200 includes a switching transistor Tr and a liquid crystal capacitance Clcd at each of grid (crossing) points of the source lines and gate lines. In FIG. 1, the source line-gate line array has source lines s1 to s960 for 960 channels that correspond to three primary colors for 320 pixels, and gate lines G1 to G240 for 240 channels that correspond to 240 pixels. The LCD panel driving circuit 100 also has driving amplifiers that supply charging potentials to the liquid crystal capacitances Clcd via the source lines s1 to s960 to perform a write operation.

In general, the distributed amplifier system is used in driving circuits for large-size LCD panels such as personal computer displays. In the distributed amplifier system, a plurality of driving amplifiers that correspond to respective gradations are provided for each of the source lines. By employing the distributed amplifier system, it becomes possible to suppress changes in the load on the respective driving amplifiers and avoid gradation irregularity across the screen even if a display pattern changes significantly.

On the other hand, the centralized amplifier system is used in those driving circuits adapted for small-size LCD panels of, for example, mobile phones and digital still cameras. In the centralized amplifier system, a plurality of driving amplifiers that correspond to respective gradations are provided for all the source lines commonly (not for each source line). In the centralized amplifier system, one driving amplifier drives all the source lines (all the channels) at each gradation. Thus, the number of the driving amplifiers to be prepared is the number of gradations, and it becomes possible to reduce a layout area necessary for an IC on which an LCD panel driving circuit is mounted. Also, power consumption can be reduced. As described above, the centralized amplifier system is a beneficial system for small-size LCD panels, and also for LCD panels for information devices, which should operate with reduced power consumption.

Japanese Patent Application Kokai No. 8-313867 discloses a power source circuit for driving a liquid crystal display device that includes a plurality of operational amplifiers corresponding to respective gradations. When the power source circuit drives a liquid crystal display device, low power consumption is achieved by deactivating the operational amplifiers except when charging and discharging liquid crystal load. Such deactivation of the operational amplifiers reduces the current to the minimum.

### SUMMARY OF THE INVENTION

There are cases in the centralized amplifier system where wiring resistances from the driving amplifiers to the loads of the LCD panel are different from channel to channel, depending on the relative positional relationships between the driving amplifiers and the LCD panel. In such cases, time required to charge the respective liquid crystal capacitances that constitute the LCD panel to a desired voltage becomes different from channel to channel in accordance with respective time constants of the wiring resistance and the liquid crystal capacitances. This causes gradation irregularity in the images displayed on the screen.

FIG. 2 of the accompanying drawings illustrates a transition of charging potentials on the source lines s480 and s960 in one cycle for scanning one gate line. The source line s480 extends in the middle of the LCD panel in the height direction of the LCD panel, and the source line s960 extends along the right edge of the LCD panel (see FIG. 1). It is seen from FIG. 2 that there is a considerable potential difference between the source lines s480 and s960 at the end of the cycle. This potential difference causes gradation irregularity.

The potential differences among the source lines s1 to s960 can be eliminated by increasing stationary current in an output stage of each driving amplifier or increasing the driving performance of the driving amplifiers. However, this is undesirable from the view point of reducing power consumption since the increase in the stationary current in the driving amplifiers increases the power consumption in the whole chip. This power consumption increase generates heat and increases the load on the power source. In addition, since drivers for small-size LCD panels are often required to be highly integrated and mounted on a single chip, miniaturized (fine) wiring is required. This causes increase in wiring resistance and creates gradation irregularity. The high integration imposes severer restrictions on the layout of the driving amplifiers, and this prevents ideal layout of the driving amplifiers, i.e., the driving amplifiers cannot be placed in the middle of the source lines.

An object of the present invention is to provide an LCD panel driving circuit that can avoid gradation irregularity of an LCD panel even if the driving circuit is highly integrated.

According to a first aspect of the present invention, there is provided an LCD panel driving circuit that includes a plurality of source lines to be connected to an LCD panel. The LCD panel driving circuit also includes a plurality of differential driving amplifiers that are provided for respective gradation levels. Each driving amplifier has two input terminals. Each driving amplifier generates a gradation signal corresponding to a write potential supplied to one of the two input terminals. The LCD panel driving circuit also includes a plurality of gradation signal lines that are provided for the respective gradation levels. The gradation signal lines are parallel to each other and extend in a lateral direction (width direction) of the LCD panel. The LCD panel driving circuit also includes a plurality of gradation selection switch parts that are provided for the respective source lines. Each switch part connects any of the gradation signal lines to the associated source line. The LCD panel driving circuit also includes a plurality of supply signal lines that are provided for the respective differential driving amplifiers and respectively connected to the gradation signal lines at first connection points. Each supply signal line sends a gradation signal, which is generated by the associated differential driving amplifier, to the gradation signal line via the first connection point thereof. The LCD panel driving circuit also includes a plurality of feedback signal lines that are provided for the respective differential driving amplifiers and respectively connected to the gradation signal lines at second connection points. The second connection points are located at positions different from the first connection points. Each feedback signal line sends a potential at the second connection point thereof to the other differential input terminal of the associated differential driving amplifier.

Because the supply signal lines supply the gradation signals to the gradation signal lines from the differential driving amplifiers via the first connection points, and the feedback signal lines supply the potentials at the second connection points, which are located at positions different from the first connection points, to the other differential input terminals of the differential driving amplifiers, gradation irregularity of the LCD panel can be avoided even if the driving circuit is highly integrated.

These and other objects, aspects and advantages of the present invention will become apparent to those skilled in the art from the following detailed description and appended claims when read and understood in conjunction with the accompanying drawings.

### BRIEF DESCRIPTION OF THE DRAWINGS

FIG. 1 is a block diagram of a configuration that drives an LCD panel using an LCD panel driving circuit.

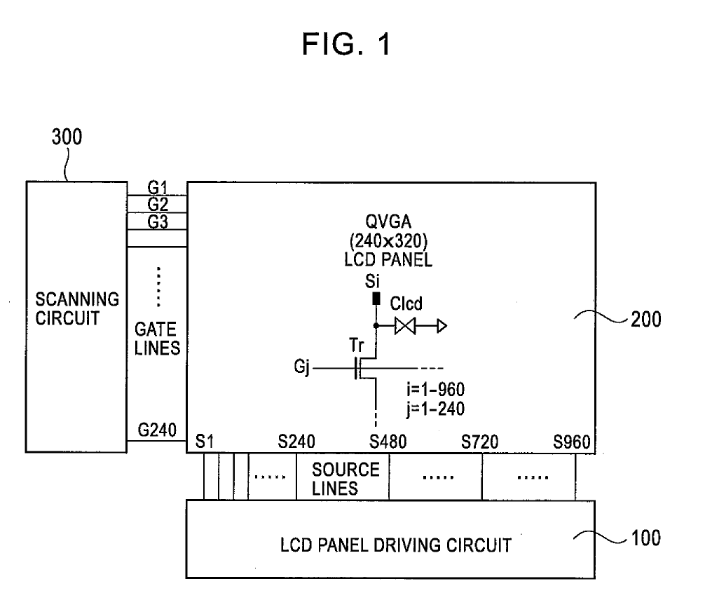

FIG. 2 is a graph showing charging waveforms on the source lines in a write operation in a conventional LCD panel driving circuit.

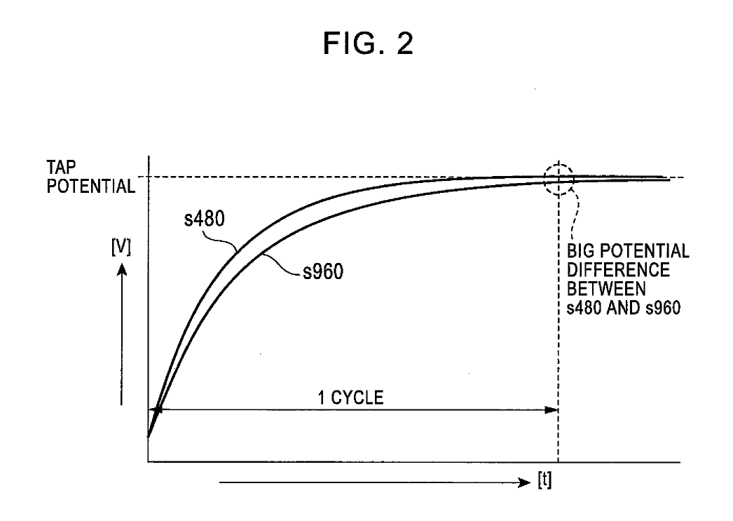

FIG. 3 is a block diagram showing a general configuration of an LCD panel driving circuit according to a first embodiment of the present invention.

FIG. 4 is a block diagram showing an internal configuration of a driving amplifier shown in FIG. 3.

FIG. 5 is a plan view showing the layout of the LCD panel driving circuit shown in FIG. 3 when the circuit is provided as a driver chip.

FIG. 6 is a block diagram showing an arrangement of feedback signal lines for introducing feedback potentials into the concentrated amplifier part shown in FIG. 3.

FIG. 7 is a graph showing charging waveforms on the source lines at the write operation.

FIG. 8 shows a block diagram showing another arrangement of the feedback signal lines according to a second embodiment of the present invention.

### DETAILED DESCRIPTION OF THE INVENTION

Embodiments of the present invention will be hereinafter described in detail with reference to the accompanying drawings.

### First Embodiment

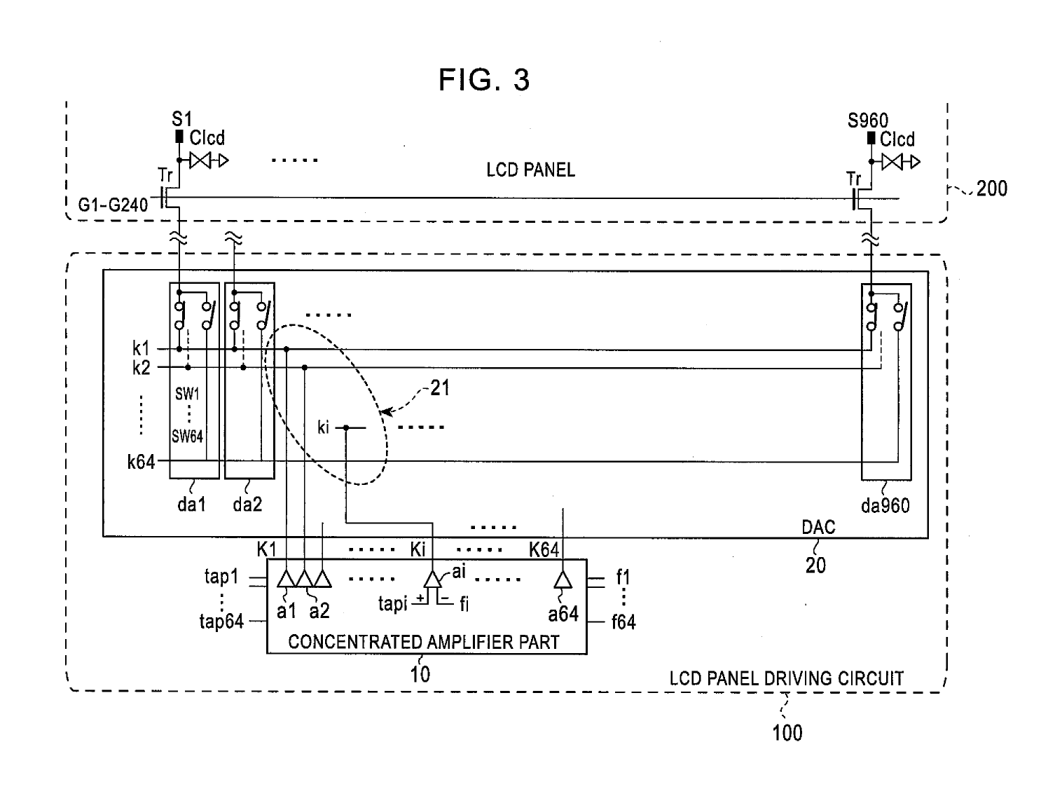

Referring to FIG. 3, a first embodiment will be described. FIG. 3 shows a general configuration of an LCD panel driving circuit 100 according to the present invention. The LCD panel driving circuit 100 includes source lines s1 to s960 that are 960 source lines for 960 channels to be connected to an LCD panel 200. The LCD panel driving circuit 100 also includes a DAC 20 that has a digital-analog conversion function, and a concentrated amplifier part 10 that has a write function to write into liquid crystal capacitances. The source lines s1 to s960 are parallel vertical lines, spaced from each other in the width (or lateral) direction of the LCD panel.

The DAC 20 includes sixty-four gradation signal lines k1 to k64 that are parallel horizontal lines, spaced from each other in the height (vertical) direction of the LCD panel. The DAC 20 also includes 960 gradation selection switch parts da1 to da960 which are provided for the respective source lines s1 to s960. Each of the gradation selection switch parts da1 to da960 includes sixty-four switches. The switches perform an open/close operation to select any one line out of the gradation signal lines k1 to k64 and connects the selected line to a corresponding source line in accordance with a gradation selection signal supplied from outside.

The operation of the DAC 20 will be explained. If the gradation selection switch part da1 selects the gradation signal line k1, then the potential of the gradation signal line k1 is supplied to the source line S1. The supplied potential is introduced to the liquid crystal capacitance Clcd via the switching transistor Tr under ON control by a scanning circuit (not shown in the figure). Then, writing of the pixel concerned is completed under OFF control by the scanning circuit. Other gradation selection switch parts da2 to da960 perform similar operation.

The concentrated amplifier part 10 includes sixty-four driving amplifiers a1 to a64. Each driving amplifier at is associated with a combination of write potential tapi, supply signal line Ki and feedback signal line fi. For example, the driving amplifier a1 operates with (or connected with) the write potential tap1, supply signal line K1, and feedback signal line f1. The driving amplifiers a1 to a64 correspond to the sixty-four gradation levels respectively. The order i is a positive number from 1 to 64 that corresponds to the respective gradation levels. A driving amplifier ai supplies a gradation signal to a supply signal line Ki, with a write potential tapi and a feedback input fi being differential inputs. The supply signal line Ki is connected at a supply portion 21 that is located on one end (left end) in the lateral direction of the gradation signal line ki. Connection points (21) of the supply signal lines K1 to K64 to the gradation signal lines k1 to k64 may be referred to as first connection points.

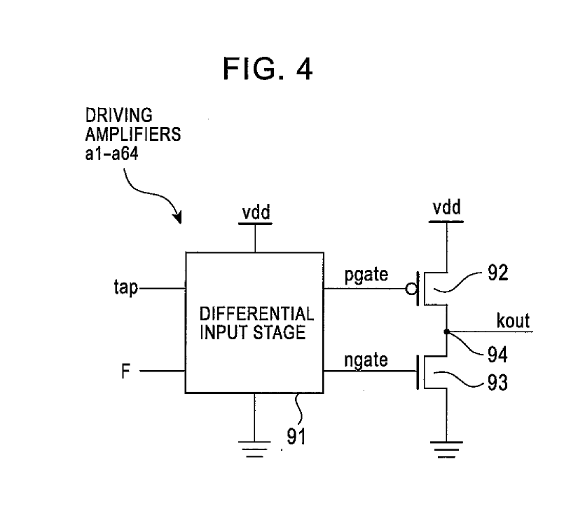

FIG. 4 shows an internal structure of the driving amplifier shown in FIG. 3. The driving amplifiers a1 to a64 have a same construction. A differential input stage 91 is connected between a power source terminal Vdd and a ground terminal and generates two potentials pgate and ngate that vary complementarily in response to a differential input between the write potential tap and a feedback potential f. The potential pgate is supplied to a gate of a PMOS transistor 92. The potential ngate is supplied to a gate of an NMOS transistor 93. The PMOS transistor 92 and the NMOS transistor 93 are connected in series between the power source terminal Vdd and the ground potential. These transistors 92 and 93 are connected at a connection point 94. A gradation signal kout is issued from the connection point 94.

It should be noted that although the driving amplifiers a1 to a64 are basically voltage follower circuits, there is a particular difference from a general configuration. A general voltage follower circuit follows a write potential tap by immediately feeding back the outputted gradation signal. In this embodiment, however, the gradation signal kout is not fed back immediately. Instead, the gradation signal kout is fed back from a particular downstream position at some distance from the connection point 94.

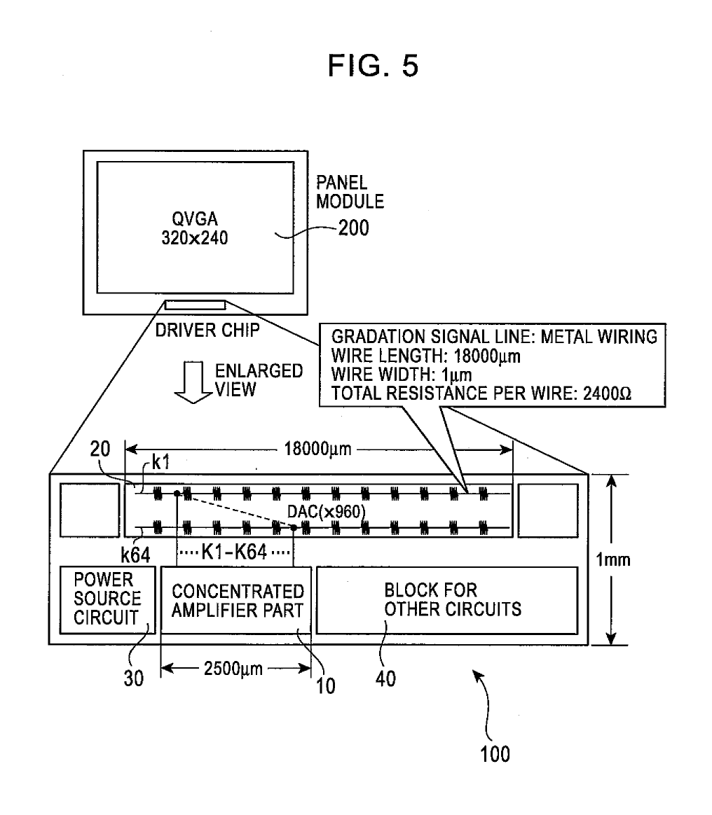

FIG. 5 shows a layout of the LCD panel driving circuit shown in FIG. 3 when the circuit is configured as a single driver chip. It should be assumed here that a panel module has a QVGA-compliant 2.5-inch LCD panel 200 and the LCD panel driving circuit 100 in the form of a driver chip.

The concentrated amplifier part 10, the DAC 20, a power source circuit 30, and a block 40 for other circuits are arranged in the LCD panel driving circuit 100. The wire length of the gradation signal lines k1 to k64 provided in the DCA 20 reaches 18000 micrometers because the gradation selection switch parts are provided with respect to each of the source lines. On the other hand, the length of the concentrated amplifier part 10 is restricted to 2500 micrometers because of the area occupied by the power source circuit 30 and the other circuits block 40. If the gradation signal lines k1 to k64 having the wire length of 18000 micrometers are provided by a metal wiring having a wire width of one micrometer, the wiring resistance per line is 2400 ohms. In a full-load condition where electric charges are supplied to the liquid crystal capacitances connected to all the source lines, a charging capacitance connected to a gradation signal line reaches several nanofarads (nF). Therefore, the potentials on the source lines change in accordance with a time constant of the wiring resistance and the charging capacitance (i.e., 2400 ohms×several nF).

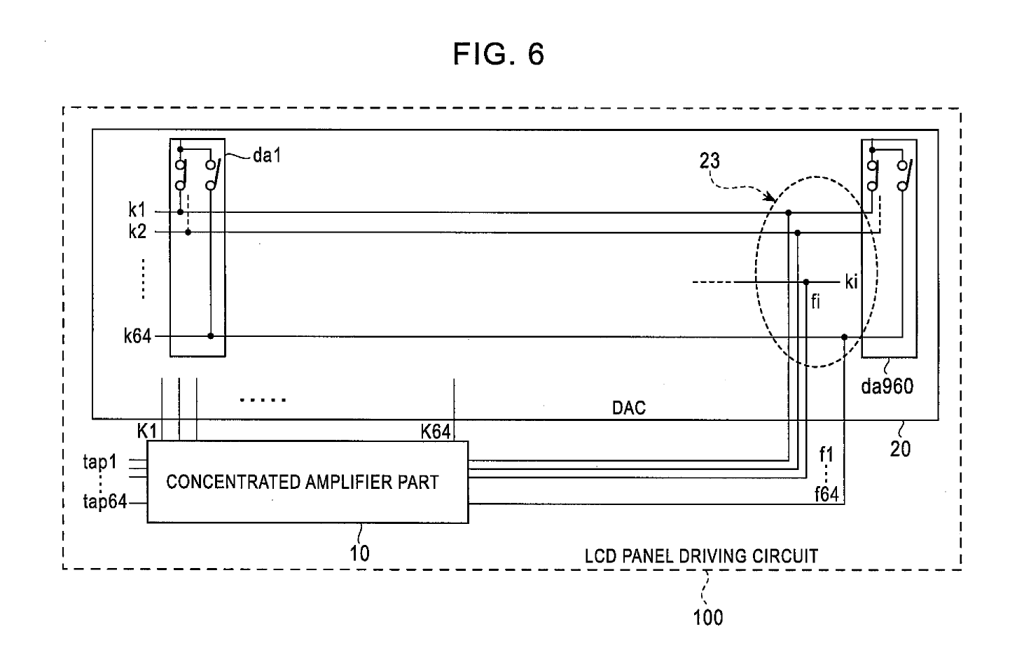

FIG. 6 shows an arrangement of the feedback signal lines for introducing feedback potentials into the concentrated amplifier part. Here, the suffix i is one to sixty-four and a feedback signal line fi is connected to the gradation signal line ki in the proximity of the source line s960. In other words, all the feedback signal lines f1 to f64 are connected to distal end portions 23 of the gradation signal lines k1 to k64. The distal end portions 23 are located at the end (right end) opposite to the left end portions 21 in the lateral extension of the gradation signal lines k1 to k64. Due to this configuration, the rise in the potentials at the farthest end portion 23 is most delayed, if compared with the constitution wherein the feedback signal lines fl to f64 are connected at a portion near the concentrated amplifier part 10. As a result, a charge stop timing of the concentrated amplifier part 10 that is determined by the potentials of the feedback signal lines f1 to f64 is also most delayed. Connection points (23) of the feedback signal lines f1 to f64 to the gradation signal lines k1 to k64 are called second connection points.

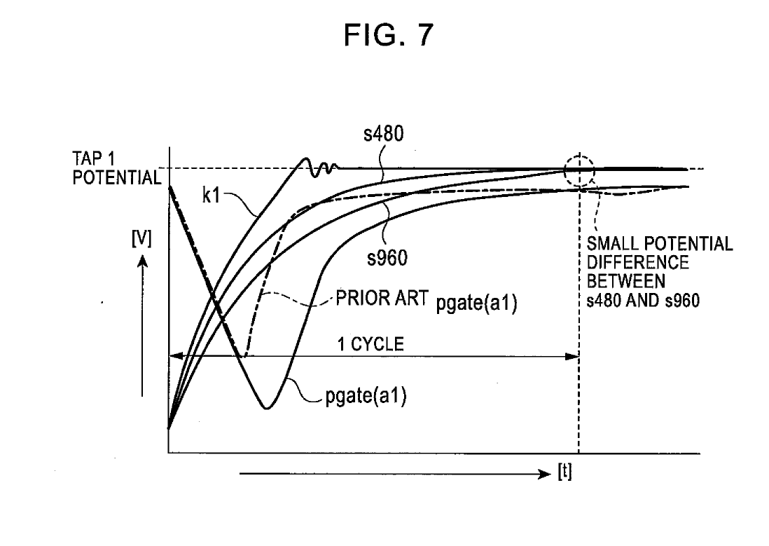

FIG. 7 shows charging waveforms on the source lines at a write operation. In other words, the figure shows a potential of the gradation signal line k1, a potential pgate in the driving amplifier a1 that supplies a gradation signal to the gradation signal line k1 (potentials for the cases of prior art and the present embodiment are shown for comparison), a potential of the source line s480 and a potential of the source line s960 in a cycle for scanning a gate line on the assumption that all of the 960 channels are in a loaded condition.

As shown in FIG. 7, the potential of the source line s960 that is located farthest from the driving amplifier al and has highest wiring resistance has an output waveform delayed from the potential of the source line s480 in early stages of the cycle. However, at the end of the cycle, a potential difference between the source lines s480 and s960 is almost eliminated. This is because the feedback signal lines introduce feedback potentials at the farthest end portion of the gradation signal lines, which is a feature of the present invention, and thus, the potential pgate maintains a drive state without turning off the output stage of the drive amplifier even when the potential of the line k1 has reached a desired voltage. The switching transistors connected to the liquid crystal capacitances perform an off operation at the end of the cycle, when potential differences among the source lines s1 to s960 are almost eliminated, and complete the write operation. Thus, the respective liquid crystal capacitances connected to the source lines s1 to s960 are uniformly charged with electric charges, and the cause of gradation irregularity is eliminated.

In the first embodiment described above, gradation irregularity of the LCD panel can be avoided by using the LCD panel driving circuit according to the present invention even if the driving circuit is highly integrated. In the present invention, conventional driving amplifiers a1 to a64 are used while a new idea is applied to the connection points of the feedback signal lines f1 to f64. A change in the connection point locations can be made merely by adding changes to a wiring layer. Thus, it is possible to maintain power consumption and a layout area to the same level as in the prior art.

Although the wire length of the feedback signal lines f1 to f64 becomes longer and this causes an increase in wiring resistance, high input impedance in the concentrated amplifier 10 allows wiring to be arranged at a minimum pitch without problems. In addition, when the LCD panel driving circuit according to the present invention is embodied as a multi-layer wiring device, it is possible to make changes to the connections of the feedback signal lines f1 to f64 by changing upper level wiring of the multi-layer wiring. Thus, it does not result in an increase in the layout area.

### Second Embodiment

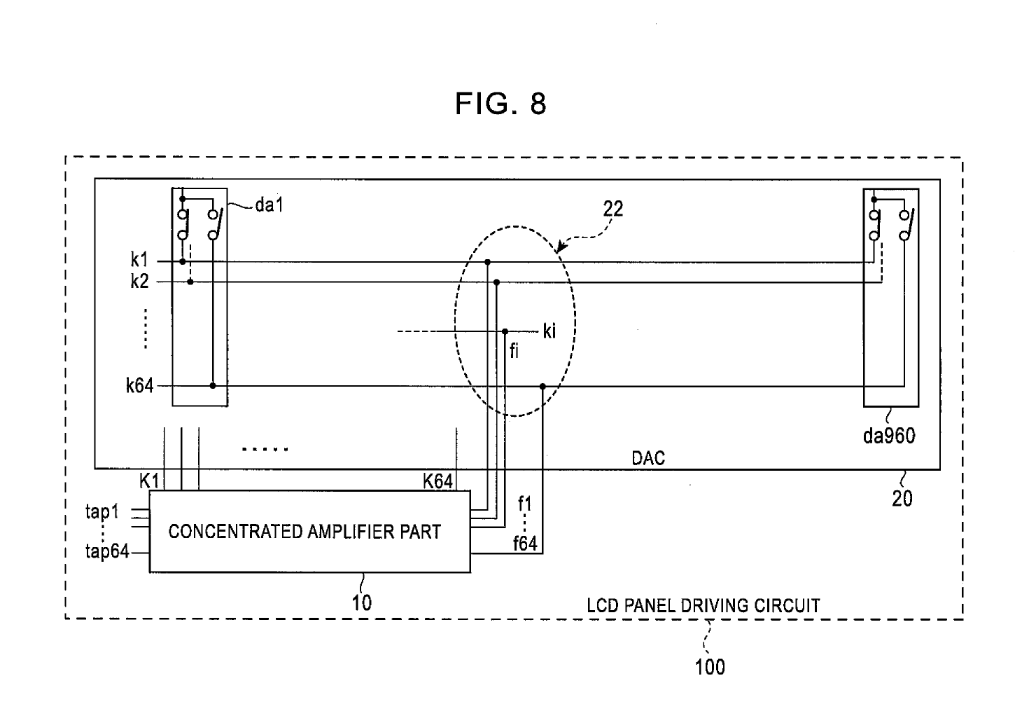

Referring to FIG. 8, a second embodiment of the present invention will be described. FIG. 8 shows a modified arrangement of feedback signal lines for introducing feedback potentials into a concentrated amplifier part 10. Similar to the first embodiment, an LCD panel driving circuit 100 includes the concentrated amplifier part 10 that supplies sixty-four gradation signals that correspond to sixty-four gradation signal lines k1 to k64, respectively. The LCD panel driving circuit 100 also includes a DAC 20 that has 960 gradation selection switch parts da1 to da960 associated with 960 source lines s1 to s960. The 960 source lines correspond to 960 channels.

In the second embodiment, the suffix i is one to sixty-four and a feedback signal line fi is connected to a gradation signal line ki in the proximity of the source line s480. In other words, unlike the first embodiment, all the feedback signal lines E1 to f64 are connected to approximate center portions 22 of the gradation signal lines k1 to k64. The center portions 22 are the center or around the center in the lateral extension of the gradation signal lines k1 to k64. The feedback signal lines introduce feedback potentials to the concentrated amplifier part 10 from the gradation signal lines. Connection points (22) of the feedback signal lines f1 to f64 to the gradation signal lines k1 to k64 are called second connection points.

In the second embodiment, gradation irregularity of the LCD panel can be avoided by employing the LCD panel driving circuit 100 even if the driving circuit is integrated. Unlike the conventional construction wherein the feedback signal lines are connected to an immediate upstream of the output of the concentrated amplifier part, the feedback signal lines f1 to f64 of the second embodiment are connected to the center portions 22 of the gradation signal lines k1 to k64 so that the feedback potentials are taken from those positions (22) where delays are relatively averaged, and such feedback potentials are sent to the driving amplifiers. Thus, the liquid crystal capacitances that are connected to the source lines s1 to s960 are charged with electric charges relatively uniformly. In the second embodiment, the feedback signal lines f1 to f64 are connected to the center portions 22 of the gradation signal lines k1 to k64. Such wiring arrangement is easier than the wiring arrangement of the first embodiment, offering a realistic solution to situations where multi-layer wiring is difficult to employ.

In the embodiments described above, the standard of the display panel is assumed to be QVGA. However, the present invention is not limited to such a standard. The present invention is applicable to high-definition display panels that are compliant with higher standards than QVGA and that require longer gradation signal lines with increased number of source lines.

This application is based on Japanese patent application No. 2007-158883 filed on Jun. 15, 2007, and the entire disclosure thereof is incorporated herein by reference.

What is claimed is:

1. An LCD panel driving circuit comprising:
a plurality of source lines to be connected to an LCD panel;
a plurality of differential driving amplifiers that are provided for respective gradation levels such that each said differential driving amplifier has two input terminals and generates a gradation signal corresponding to a write potential supplied to one of the two input terminals;
a plurality of gradation signal lines that are provided for the respective gradation levels such that the plurality of gradation signal lines are parallel to each other and extend in a lateral direction of the LCD panel;
a plurality of gradation selection switch parts that are associated with the plurality of source lines respectively such that each said gradation selection switch part connects any of said gradation signal lines to the associated source line;
a plurality of supply signal lines that are associated with the plurality of differential driving amplifiers respectively and connected to said plurality of gradation signal lines at first connection points respectively such that each said supply signal line supplies the gradation signal generated by the associated differential driving amplifier to the associated gradation signal line via the first connection point thereof; and
a plurality of feedback signal lines that are provided for the plurality of differential driving amplifiers respectively and connected to said plurality of gradation signal lines at second connection points respectively, said second connection points being located at positions different from said first connection points, such that each said feedback signal line supplies a potential at the second connection point thereof to the other input terminal of the associated differential driving amplifier.

2. The LCD panel driving circuit according to claim 1, wherein said first connection points are located on or near one end in said lateral direction of said gradation signal lines, and said second connection points are located on or near the other end in said lateral direction.

3. The LCD panel driving circuit according to claim 1, wherein said first connection points are located on or near one end in the lateral direction of said gradation signal lines, and said second connection points are located at an approximately intermediate position in said lateral direction.

4. The LCD panel driving circuit according to claim 1, wherein said display panel is a high-definition panel that is compliant with QVGA (Quarter Video Graphics Array) standard or standards higher than the QVGA standard.
